(19) United States
(12) Patent Application Publication
(10) Pub. No.: US 2023/0224094 A1
(43) Pub. Date: Jul. 13, 2023

(54) METHOD AND APPARATUS FOR CONTROLLING RE-TRANSMISSIONS

(71) Applicant: Samsung Electronics Co., Ltd., Suwon-si, Gyeonggi-do (KR)

(72) Inventor: Mythri HUNUKUMBURE, Staines (GB)

(21) Appl. No.: 17/907,533

(22) PCT Filed: Mar. 25, 2021
(86) PCT No.: PCT/KR2021/003714

§ 371 Date: Sep. 27, 2022

(30) Foreign Application Priority Data
Mar. 31, 2020 (GB) 2004760.1

(51) Int. Cl. H04L 1/1822; H04L 1/00; H04W 76/28

(52) U.S. Cl. CPC H04L 1/1822; H04L 1/0026; H04W 76/28

(57) ABSTRACT

The present disclosure relates to a 5G communication system or a 6G communication system for supporting higher data rates beyond a 4G communication system such as long term evolution (LTE). Disclosed is a method by a base station for use in a non-terrestrial network (NTN) comprising: transmitting one of a predetermined number of re-transmissions including a packet in a blind re-transmission mode to an user equipment (UE); receiving a channel quality indicator (CQI) message after the transmission; in response to a particular configuration of the received CQI message, terminating transmission of any remaining of the predetermined number of re-transmissions.

### CROSS-REFERENCE TO RELATED APPLICATIONS

This application is a U.S. National Phase Entry of PCT International Application No. PCT/KR2021/003714, which was filed on Mar. 25, 2021, and claims priority to United Kingdom Applications No. 2004760.1 filed Mar. 31, 2020 in the United Kingdom Intellectual Property Office, the contents of which are incorporated herein by reference.

### BACKGROUND

### 1. Field

The disclosure relates to improvements in the Hybrid automatic repeat request, HARQ, used in a Non-Terrestrial Network, NTN. An NTN is a type of telecommunication network which utilizes base stations positioned on one or more aerial platforms, such as aircraft, airships and satellites.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that may be, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Due to the large propagation delays in NTN, there is an acknowledged need for pre-emptive (blind) re-transmissions by disabling HARQ feedback from User Equipment, UE, in the downlink. While this paves the way for reducing the wait times for packet re-transmissions, the UE has no feedback mechanism to indicate when a packet can be reconstructed successfully.

In particular, there may be a propagation delay in the region of 2 ms-500 ms for a satellite NTN, and this delay poses particular problems.

In a regular HARQ system, the UE is able to respond with a NACK signal if it is unable to successfully decode a given transmission, triggering the base station to re-transmit until an ACK, indicating successful decode, is received by it. The relatively long delays in NTN render this approach impractical.

Instead, a blind re-transmission scheme may be implemented as a set number of re-transmissions for a given channel quality, as indicated by Uplink Channel Quality Indicator (UL CQI). In this case, “blind” means that no acknowledgement process is built into the system and the scheme is a type of “brute force” approach whereby a set number of re-transmissions are sent in the hope or expectation that the receiver (the UE) will successfully decode them. This decoding can be performed by combining the failed packets in a method such as that defined by ‘Chase combining’ or by any other suitable HARQ reception method known in the art.

### SUMMARY

However, it may be possible for the UE to be able to decode the message before all of these re-transmissions are received. Particularly, for sensor type devices in this case, having to be in the RRC connected mode for the completion of all re-transmissions is detrimental to power efficiency and the transmitting base station (gNB) also wastes radio resources by performing redundant re-transmissions. Embodiments of the present disclosure address these issues associated with the HARQ process used in NTNs and other issues not explicitly mentioned herein.

According to an embodiment of the disclosure there is provided an apparatus and method as set forth in the appended claims. Other features of the invention will be apparent from the dependent claims, and the description which follows.

According to an aspect of the disclosure, there is provided a method by a base station for use in a non-terrestrial network (NTN), comprising: transmitting one of a predetermined number of re-transmisisons including a packet in a blind re-transmission mode to an user equipment (UE); receiving a channel quality indicator (CQI) message after the transmission; in response to a particular configuration of the received CQI message, terminating transmission of any remaining of the predetermined number of re-transmissions.

According to an aspect of the disclosure, there is provided a method by a user equipment (UE) for use in a non-terrestrial network (NTN), comprising: receiving one of a predetermined number of re-transmissions including a packet in a blind re-transmission mode from a base station; determining whether the packet is successfully decoded or not based on the reception; if the packet is decoded successfully, transmitting a channel quality indicator (CQI) message having a particular configuration to indicate the successful decoding of the packet; and after transmitting the CQI message, determining that transmission of any remaining of the predetermined number of re-transmissions is terminated.

According to an embodiment of the disclosure, there is provided a system providing for implicit feedback of successful packet detection (ACK) from the UE to support pre-emptive HARQ operations. For many low data rate, sensor based (IoT type) applications in NTN, maximising the power and resource usage efficiency are critical. Embodiments allow the UE (or sensor device) to quickly acknowledge implicitly the successful detection of a packet through CQI messaging and to indicate to the satellite gNB to terminate the HARQ process. Further, embodiments modify the existing cDRx procedure to further enhance power savings.

Although a few preferred embodiments of the disclosure have been shown and described, it will be appreciated by those skilled in the art that various changes and modifications might be made without departing from the scope of the invention, as defined in the appended claims.

### BRIEF DESCRIPTION OF THE DRAWINGS

In order to illustrate the technical solutions of the embodiments of the present disclosure more clearly, the drawings accompanying the description of the embodiments will be briefly described as follows. Obviously, the drawings illustrate only some of the embodiments of the present disclosure. For those skilled in the art, other drawings may be obtained from these drawings without any creative work.

For a better understanding of the invention, and to show how embodiments of the same may be carried into effect, reference will now be made, by way of example only, to the accompanying diagrammatic drawings in which:

FIG. 1 shows a general representation of a Non-Terrestrial Network;

FIG. 2 shows a Blind HARQ re-transmission scheme according to the prior art;

FIG. 3 shows a HARQ re-transmission scheme according to an embodiment;

FIG. 4 shows a flowchart of a method according to an embodiment;

FIG. 5 shows a block diagram of a gNB according to an embodiment; and

FIG. 6 shows a block diagram of a UE according to an embodiment.

### DETAILED DESCRIPTION

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Through the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim of the present invention are to be understood to be applicable to any other aspect, embodiment, example or claim described herein unless incompatible therewith.

Certain examples of the present disclosure provide methods, apparatus and systems for improving security in a network. For example, certain examples of the present disclosure provide enhancements to security aspects in 5GS. However, the skilled person will appreciate that the present invention is not limited to these examples, and may be applied in any suitable system or standard, for example one or more existing and/or future generation wireless communication systems or standards.

The following examples are applicable to, and use terminology associated with, 3GPP 5G. However, the skilled person will appreciate that the techniques disclosed herein are not limited to 3GPP 5G. For example, the functionality of the various network entities and messages disclosed herein may be applied to corresponding or equivalent entities and messages in other communication systems or standards. Corresponding or equivalent entities and messages may be regarded as entities and messages that perform the same or similar role within the network. The skilled person will also appreciate that the transmission of information between network entities is not limited to the specific form or type of messages described in relation to the examples disclosed herein.

A particular network entity may be implemented as a network element on a dedicated hardware, as a software instance running on a dedicated hardware, and/or as a virtualised function instantiated on an appropriate platform, e.g. on a cloud infrastructure.

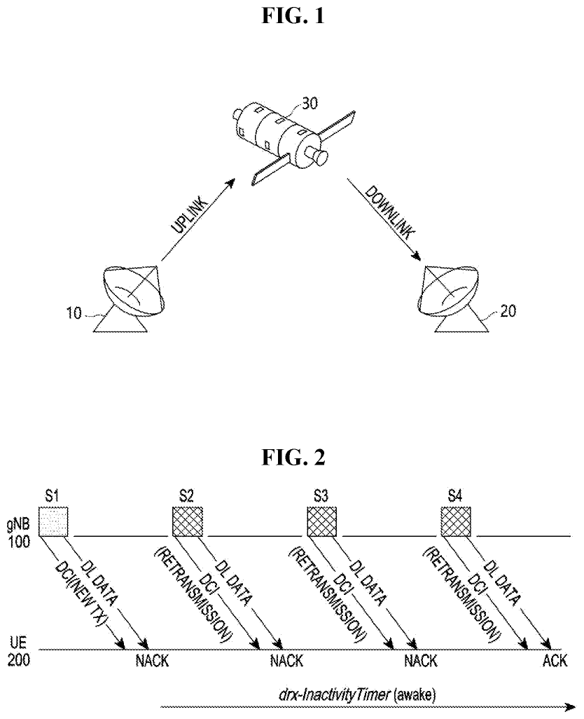

FIG. 1 shows a general representation of a Non-Terrestrial Network.

Referring to FIG. 1, it illustrates how signals are transmitted from a ground station 10 to a ground station 20 via a satellite-based gNB 30. The ground stations 10, 20 can take the form of any known form of UE, such as a mobile telephone or a remote sensor, such as an IoT device.

An embodiment of the disclosure provides an implicit HARQ-ACK feedback mechanism in the case of NTN single transport block (1 TB) transmissions. This type of single TB transmissions are typically used in massive Machine Type Communication (MTC) systems, where energy saving and efficient radio resource utilization are key aspects, even for NTN based massive MTC.

Embodiments of the disclosure utilize the pre-existing CQI procedure, to report the likely CQI level for the successful Chase combined packet (after n re-transmissions), instead of the received individual packet. Further, the pre-existing cDRx procedure (connected DRx) is adapted to provide further power saving.

Prior art procedures related to NTN recommend feedback-disabled blind/pre-emptive HARQ schemes in the downlink. Such blind HARQ schemes may contain a fixed number (N) of re-transmissions per packet, with the number N depending on the channel conditions. While for data/voice applications in normal UEs, such a blind HARQ scheme will reduce the latencies and improve the QoS, for mMTC type applications, further energy/radio resource savings can be achieved if the re-transmissions can be terminated once the packets are successfully decoded by the device. This, however, is not typically possible in a blind scheme with no possible feedback mechanism.

Many of the mMTC type communications involve sporadic transmissions, like a single transport block (TB) transmission in the downlink, some uplink indication and then long periods of inactivity. In this kind of scenario, embodiments of the disclosure find particular utility.

FIG. 2 shows a Blind HARQ re-transmission scheme according to the prior art;

With the blind re-transmission scheme, as shown in FIG. 2, a number (N) of re-transmissions from the gNB 100 will occur without the ACK/NACK feedback from the UE 200 or device. This means that the device 200 will have to be awake and in ‘listen’ mode even if the data packet can be decoded successfully before the N re-transmissions are complete. This is wasteful of both radio resource and power, particularly for the device 200.

Although prior art solutions are available which propose including the longer RTT of the NTN in a ‘drx-HARQ-RTT-TimerDL’ DRX timer to reduce the ‘awake’ time of the device in between the HARQ re-transmissions, there can still be unwanted wake up and listen cycles for the device. Further, the transmitting satellite gNB 100 or repeater will waste radio resources in having to complete the N re-transmissions. This would be costly, particularly in the case of mMTC type uni-cast transmissions to many thousands of devices 200.

According to the prior art, in terms of CQI, the current agreement in the Fifth Generation (5G) operating standards is that the UE should transmit the CQI index from a table indicating the channel quality for decoding the last received TB for a block error rate (BLER) of either 10-1 or 10-5. This indicates to the gNB which MCS should be used in the next TB in the downlink transmission, as a form of Adaptive Modulation and Coding (AMC).

According to an embodiment of the disclosure, for an mMTC device in a blind HARQ re-transmission scenario, as set out above, a procedure is provided to develop the TB, constructed from chase-combining of the successive HARQ re-transmissions (which would happen anyway in the prior art HARQ procedure) and if the packets are successfully decoded, use the CQI transmission from the UE to indicate the MCS level for the successfully constructed packet, rather than the last received packet (or TB) from the gNB. In this way, the CQI transmission which occurs ordinarily can be effectively re-purposed to provide a means by which the blind HARQ procedure can be curtailed as soon as the UE has successfully decoded the transmission from the gNB.

In an embodiment, the CQI level for the chosen BLER is used, in relation to the Chase combined (constructed) packet of the re-transmissions at step n, if the constructed packet can be accurately decoded. If not, the CQI level indicated should be for the last received individual re-transmission from the gNB. This CQI will effectively be re-purposed to indicate NACK and if there needs to be any MCS change for the next HARQ re-transmission.

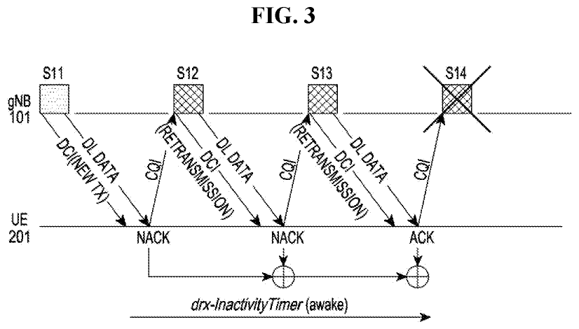

In FIG. 3, an embodiment of the disclosure is illustrated, with the assumption that the CQI is transmitted after every HARQ re-transmission. With a lower frequency CQI mode for example, the CQI can be transmitted only when a successful chase combining will occur at the UE/device. In either case this indication of a higher level CQI than the actual MCS used in the packets can be used by the gNB to stop the (n+1)-th re-transmission saving radio resources. Also it allows the UE/device to move into the DRX ‘sleep’ mode earlier, saving critical device power in mMTC applications.

In detail, in FIG. 3, at S11 the gNB 101 transmits a TB to the UE 201. The UE is not able to properly decode this and so the CQI transmission is selected to indicate this to the gNB 101. As a result, the gNB transmits the TB again at S12. Again, the UE 201 is unable to decode this transmission and so the CQI transmission is selected to indicate this to the gNB 101. At step S13, the gNB again transmits the TB and this time the UE 201 is able to decode the transmission properly and so the CQI transmission selected this time differs from the previous CQI transmission and effectively terminates the HARQ transmission so that step S14, which would otherwise have happened, is cancelled. It is not mandatory to set the CQI periodicity so that there is a transmission after every re-transmission of the packet. The CQI, for example, can also be set to be event driven, i.e. it can be arranged such that CQI is used within the HARQ process, as set out above, only when the packet is re-constructed correctly.

Embodiments of the disclosure find particular utility in single transport block (TB) transmissions, common in mMTC. However, if the TB exceeds a single packet transmission in the downlink Physical Data Shared Channel (PDSCH), the scheme can be applied to the last packet transmission of the TB, in the PDSCH. Being the single (or the last) packet, the gNB 101 does not have to rely on the CQI to set the MCS level for the next packet in this transmission chain. Therefore, setting the CQI to reflect the channel quality for the Chase-combined packet, rather than the individual re-transmission, does not ‘mis-lead’ the gNB.

As mentioned above, the potential savings in power efficiency for the device and the radio resource usage efficiency for the gNB can be significant with use of embodiments of the disclosure. Particularly for Low Earth Orbit (LEO) and Medium Earth Orbit (MEO) satellites, where there is relative motion between the satellite gNB and the device on the ground, the radio channel conditions can change quickly. Thus, a pre-configured number of fixed re-transmissions can be an over-estimate in many situations, since it will have to cater for the worst case scenario which will not always be the case. In these cases, embodiments of the disclosure allow the device to indicate successful decoding through the CQI mechanism set out above almost immediately and also allows the device to move onto a power saving DRX state, described shortly.

Similarly embodiments of the disclosure allow radio resources to be used more efficiently. In unicast periodic transmissions to each of the sensor devices, embodiments allow the gNB to terminate a HARQ process as soon as the packet is reconstructed by the device, without having to go through all of the N re-transmissions, which would otherwise be scheduled to occur. Overall, this will enable more devices to be supported with the same radio resources in respect of this type of single TB downlink transmission.

The application of connected mode Discontinuous Reception (cDRX) has been proposed for use in NTN, to further increase the power efficiency of the devices. In Discontinuous Recerption (DRX), the UE enters into a sleep mode for a certain period of time and wakes up at a predetermined future time to be able to receive transmissions. The schedule of sleep/wake times is known to both UE and gNB, allowing this to be coordinated.

In connection with the use of HARQ in NTN systems, modifications to the cDRx timer ‘drx-HARQ-RTT-TimerDL’ may be made to include the longer round trip time (RTT) of the satellite links. Therefore, embodiments include device sleep time in between the packet receive intervals of the HARQ process shown in FIG. 2. In the default N re-transmission blind HARQ operation, as shown in FIG. 2, the above referenced ‘drx-HARQ-RTT-TimerDL’ timer activates sleep times in all the intervals between the N packet receptions.

In an embodiment of the disclosure, the DRX timer operation is further modified. In mMTC related NB-IoT standards, an extended DRX (or eDRX) mode is defined for the devices to go into long sleep cycles after a period of activity. If the particular single TB mMTC transmission described herein benefits from a long sleep cycle afterwards, the gNB can be configured to issue the activation of the eDRX timer (or similar timer in NTN) as soon as the CQI implicit indication of the ‘ACK’ is received by the gNB from the device, as set out above, indicating successful decoding. Such a timer indication over-rides the current cDRX configuration (including the ‘drx-HARQ-RTT-TimerDL’ timer). Thus the UE/device would activate one more of the ‘listen’ modes in the cDRX cycle after the ‘drx-HARQ-RTT-TimerDL’ timer expires. In this listen mode, it will receive the eDRX, or similar long term sleep mode, timer activation from the gNB, with possibly an override command. This feature of embodiments of the disclosure will enable further power saving, particularly in sensor-type devices connected to a NTN.

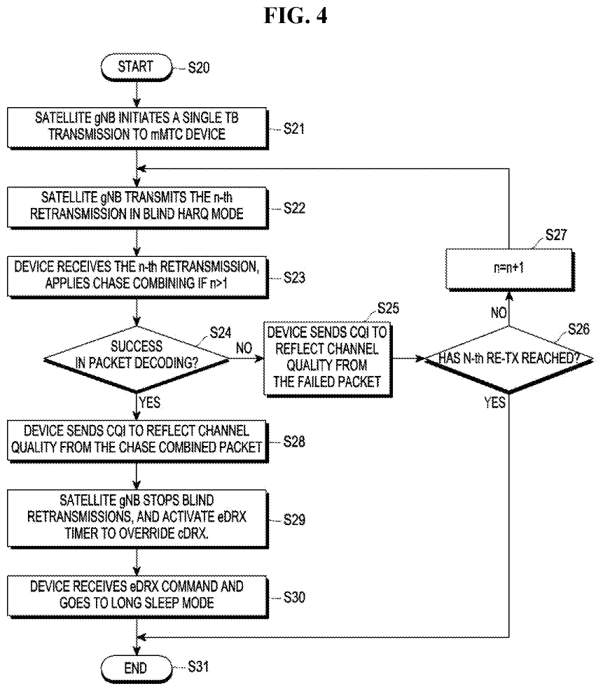

FIG. 4 shows a flowchart which sets out various steps comprised in a method according to an embodiment of the disclosure.

After starting at S20, at S21, the satellite gNB may initiate a single TB transmission to a device (that may be an UE or a mMTC device).

At S22, the satellite gNB may transmit the n-th re-transmission (including a TB or a packet) among a predetermined number (N) re-transmissions configured in blind HARQ mode (that may be pre-emptive re-transmissions by disabling HARQ feedback).

At S23, the device may receive the n-th re-transmission and applies Chase combining if n>1.

At S24, a determination may be made at the device whether the packet was successfully decoded or not based on the n-th re-transmission. If is not, then flow continues to S25, where the device may send a CQI message to reflect the channel quality connected with the failed packet decode attempt.

At step S26, a determination may be made if the final N-th attempt at re-transmission has been reached (that may be n=N ?). If not, then the re-transmission counter is incremented by 1 at S27 and flow returns to S22.

If, at step S26, the final N-th re-transmission has occurred, then the procedure ends at S31. In such a case, it will not have been possible to decode the transmission.

If at step S24, it is determined that the packet has been decoded successfully, then at S28 the device may send a CQI message to reflect channel quality in connection with the Chase-combined packet.

At S29, the satellite gNB may stop the re-transmissions in the blind HARQ mode and may, optionally, activate the eDRX timer to override the cDRX timer to facilitate further power savings at the device.

At S30, if the eDRX timer is activated, the device may enter a long sleep mode and will re-awaken at an agreed scheduled time, ready to receive again.

The procedure then stops at S31.

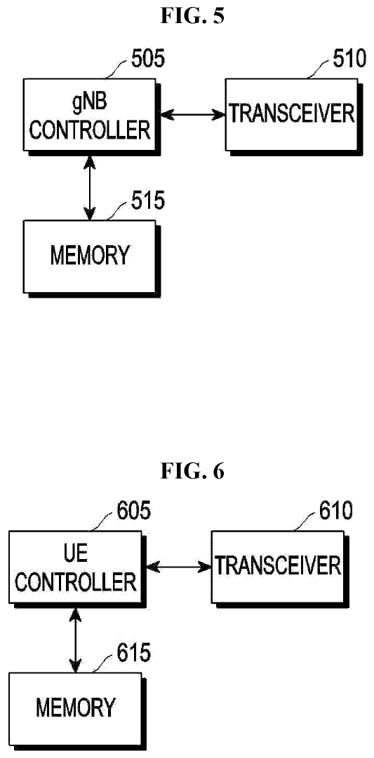

FIG. 5 illustrates a block diagram of a gNB according to an embodiment.

As shown in FIG. 5, the gNB may comprise a transceiver 510, a controller (that may include at least one processor) 505, and a memory 515. The controller 505 may be configured to control the transceiver 510 and the memory 515 according to at least one of the embodiments described in the disclosure.

FIG. 6 illustrates a block diagram of a UE according to an embodiment.

As shown in FIG. 6, the UE may comprise a transceiver 610, a controller (that may include at least one processor) 605, and a memory 615. The controller 605 may be configured to control the transceiver 610 and the memory 615 to perform the method according to at least one of the embodiments described in the disclosure.

By use of embodiments of the invention, a more efficient HARQ scheme for use in NTN mMTC may be realised. The efficiency is measured in terms of radio resource usage and power consumption at the ground devices, in particular, which is often an important consideration. Devices such as sensors operating in an mMTC manner are particularly assisted by embodiments of the invention.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Particular aspects of the present disclosure may be implemented as a computer-readable code in a computer-readable recording medium. The computer-readable recording medium may be a data storage device, which can store data which can be read by a computer system. Examples of the computer readable recording medium may include a Read-Only Memory (ROM), a Random Access Memory (RAM), a CD-ROM, a magnetic tape, a floppy disk, an optical data storage device, and a carrier wave (such as data transmission through the Internet). The computer-readable recording medium may be distributed through computer systems connected to the network, and accordingly, the computer-readable code may be stored and executed in a distributed manner. Further, functional programs, codes and code segments for achieving the present disclosure may be easily interpreted by programmers skilled in the art which the present disclosure pertains to.

The above-described methods and apparatuses according to embodiments of the present disclosure may be implemented in the form of hardware, software, or a combination of hardware and software. Any such software may be stored, e.g., in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. A method according to an embodiment of the present disclosure may be implemented by a computer or portable terminal including a controller and a memory, wherein the memory is one example of machine-readable storage media suitable to store a program or programs including instructions for implementing the embodiments of the present disclosure.

Accordingly, the present disclosure includes a program for a code that implements the apparatus and method described in the appended claims of the specification and a machine (a computer or the like)-readable storage medium for storing the program. Further, the program may be electronically carried by any medium such as a communication signal transferred through a wired or wireless connection, and the present disclosure appropriately includes equivalents thereof.

Further, an apparatus according to various embodiments of the present disclosure may receive the program from a program providing device that is wiredly or wirelessly connected thereto, and may store the program. The program providing device may include a program including instructions through which a program processing device performs a preset content protecting method, a memory for storing information required for the content protecting method, a communication unit for performing wired or wireless communication with the program processing device, and a controller for transmitting the corresponding program to a transceiver at the request of the program processing device or automatically.

While the present disclosure has been particularly shown and described with reference to certain embodiments thereof, it will be understood by those of ordinary skill in the art that various changes in form and details may be made therein without departing from the scope of the present disclosure as defined by the following claims and their equivalents.

1. A method by a base station for use in a non-terrestrial network (NTN), comprising:
transmitting one of a predetermined number of retransmissions including a packet in a blind retransmission mode to an user equipment(UE);
receiving a channel quality indicator (CQI) message after the transmission;
in response to a particular configuration of the received CQI message, terminating transmission of any remaining of the predetermined number of retransmissions.

2. (canceled)

3. The method of claim 1, wherein each of the retransmissions fits into a single transport block (TB) and is reflected in the same packet on a downlink physical data shared channel (PDSCH).

4. The method of claim 1, wherein the particular configuration of the CQI message is either a predetermined value related to a modulation coding scheme, MCS, level for a reconstructed packet, formed through chase-combining of at least two retransmissions, or a change from a previous CQI message.

5. The method of claim 1, wherein if the number of the retransmissions exceeds a single packet transmission in a PDSCH, the CQI message is transmitted in response to the last retransmission of the retransmissions.

6. The method of claim 1, wherein the UE is a mass machine type communication (mMTC) device.

7. The method of claim 1, wherein a message to initiate a sleep mode is transmitted from the base station to the UE, when the transmission is terminated.

8. The method of claim 7, wherein the sleep mode is initiated by activating an eDRX (enhanced discontinuous reception) timer.

9. The method of claim 8, wherein the eDRX timer over-rides any existing cDRX (connected mode DRX) timer operating at the UE.

10. An apparatus of a base station for use in a non-terrestrial network (NTN), comprising:
a transceiver configured to transmit one of a predetermined number of retransmissions including a packet, in a blind retransmission mode to an user equipment(UE), and receive a channel quality indicator (CQI) message after transmitting the retransmission; and
a controller coupled with the transceiver and configured to, in response to a particular configuration of the received CQI message, terminate the transmission of any remaining of the predetermined number of retransmissions.

11. An apparatus of a user equipment (UE) for use in a non-terrestrial network (NTN), comprising:
a transceiver configured to receive one of a predetermined number of retransmissions including a packet in a blind retransmission mode from a base station, and, if the packet is successfully decoded based on the reception, transmit a channel quality indicator (CQI) message having a particular configuration to indicate the successful decoding of the packet; and
a controller coupled with the transceiver and configured to, after transmitting the CQI message, determine that the transmission of any remaining of the predetermined number of retransmissions is terminated.

12. The apparatus of claim 10, wherein each of the retransmissions fits into a single transport block (TB) and is reflected in the same packet on a downlink physical data shared channel (PDSCH).

13. The apparatus of claim 10, wherein the particular configuration of the CQI message is either a predetermined value related to a modulation coding scheme, MCS, level for a reconstructed packet, formed through chase-combining of at least two retransmissions, or a change from a previous CQI message.

14. The apparatus of claim 10, wherein if the number of the retransmissions exceeds a single packet transmission in a PDSCH, the CQI message is transmitted in response to the last retransmission of the retransmissions.

15. The apparatus of claim 11, wherein each of the retransmissions fits into a single transport block (TB) and is reflected in the same packet on a downlink physical data shared channel (PDSCH).

16. The apparatus of claim 11, wherein the particular configuration of the CQI message is either a predetermined value related to a modulation coding scheme, MCS, level for a reconstructed packet, formed through chase-combining of at least two retransmissions, or a change from a previous CQI message.

17. The apparatus of claim 11, wherein if the number of the retransmissions exceeds a single packet transmission in a PDSCH, the CQI message is transmitted in response to the last retransmission of the retransmissions.

18. A method by an user equipment (UE) for use in a non-terrestrial network (NTN), comprising:
receiving one of a predetermined number of retransmissions including a packet in a blind retransmission mode from a base station;
determining whether the packet is successfully decoded or not based on the reception;
if the packet is decoded successfully, transmitting a channel quality indicator (CQI) message having a particular configuration to indicate the successful decoding of the packet; and
after transmitting the CQI message, determining that transmission of any remaining of the predetermined number of retransmissions is terminated.

19. The method of claim 18, wherein each of the retransmissions fits into a single transport block (TB) and is reflected in the same packet on a downlink physical data shared channel (PDSCH).

20. The method of claim 18, wherein the particular configuration of the CQI message is either a predetermined value related to a modulation coding scheme, MCS, level for a reconstructed packet, formed through chase-combining of at least two retransmissions, or a change from a previous CQI message.
